(19) United States
(12) Patent Application Publication
(10) Pub. No.: US 2011/0051065 A1
(43) Pub. Date: Mar. 3, 2011

(54) LIQUID CRYSTAL DEVICE AND MANUFACTURING METHOD OF THE SAME

(75) Inventors: Dong-Gi SEONG, Asan-si (KR); Jae-Jin Lyu, Yongin-si (KR); Ki-Chul Shin, Asan-si (KR); Seung-Beom Park, Seoul (KR); Keun-Chan Oh, Cheonan-si (KR); Yoon-Sung Um, Yongin-si (KR); Su-Jeong Kim, Seoul (KR); Youn-Hak Jeong, Cheonan-si (KR); Jun-Hyup Lee, Seoul (KR)

(73) Assignee: Samsung Electronics Co., Ltd., Suwon-si (KR)

(21) Appl. No.: 12/816,842

(22) Filed: Jun. 16, 2010

(30) Foreign Application Priority Data
Aug. 26, 2009 (KR) 10-2009-0079468

(51) Int. Cl. G02F 1/1337; H01J 9/00

(52) U.S. Cl. 349/123; 445/24

(57) ABSTRACT

A liquid crystal display and a manufacturing method are provided. A liquid crystal display according to an exemplary embodiment of the present invention includes a first substrate, a second substrate facing the first substrate, a field generating electrode disposed on at least one of the first substrate and the second substrate, an alignment layer disposed on the field generating electrode, and a liquid crystal layer interposed between the first substrate and the second substrate, including liquid crystal molecules and a second alignment polymer, wherein the first alignment polymer is formed by light-irradiating the alignment agent and the first alignment aids and the second alignment polymer is formed by light-irradiating the liquid crystal molecules and the second alignment aids, and the first alignment aids and the second alignment aids include a mesogen and a photo-polymerizable group coupled to the mesogen.

### CROSS REFERENCE TO RELATED APPLICATION

This application claims priority from and the benefit of Korean Patent Application No. 10-2009-0079468, filed on Aug. 26, 2009, which is hereby incorporated by reference for all purposes as if fully set forth herein.

### BACKGROUND OF THE INVENTION

1. Field of the Invention

Exemplary embodiments of the present invention relate to a liquid crystal display and a manufacturing method thereof.

2. Discussion of the Background

Liquid crystal displays are widely used as flat panel displays. A liquid crystal display may include two display panels on which field generating electrodes are formed, and a liquid crystal layer interposed between the panels. In the liquid crystal display, voltages may be applied to the field generating electrodes so as to generate an electric field over the liquid crystal layer, such that the alignment of liquid crystal molecules of the liquid crystal layer may be determined by the electric field. Accordingly, the polarization of incident light is controlled, thereby resulting in image display.

A liquid crystal display may use a liquid crystal material that is suitable to control the transmittance of light and result in the display of desired images. Particularly, according to the various uses of the liquid crystal display, characteristics such as low voltage driving, a high voltage holding ratio (VHR), a wide viewing angle characteristic, a wide range of operation temperature, and high speed response are beneficial.

The liquid crystal layer may include a liquid crystal composition that is mixed with the liquid crystal molecules of various kinds to achieve various beneficial characteristics.

Further, initial alignment of the liquid crystal molecules is important.

To obtain good initial alignment of the liquid crystal molecules, pre-tilt thereof is often uniformly controlled. When the pre-tilt of the liquid crystal molecules is non-uniform, the initial alignment of the liquid crystal molecules may be scattered such that it is difficult to control the light passing through the liquid crystal layer. In this case, the contrast ratio may be decreased, and the difference of the pre-tilt may be shown as an afterimage such that the display characteristics may be deteriorated.

### SUMMARY OF THE INVENTION

Exemplary embodiments of the present invention prevent the deterioration of the voltage holding ratio generated when only one of a liquid crystal layer and an alignment layer includes a reactive mesogen.

Additional features of the invention will be set forth in the description which follows, and in part will be apparent from the description, or may be learned by practice of the invention.

An exemplary embodiment of the present invention discloses a liquid crystal display including a first substrate, a second substrate facing the first substrate, a field generating electrode disposed on at least one of the first substrate and the second substrate, an alignment layer disposed on the field generating electrode, the alignment layer including an alignment agent and a first alignment polymer, and a liquid crystal layer interposed between the first substrate and the second substrate, the liquid crystal layer including liquid crystal molecules and a second alignment polymer, wherein the first alignment polymer is formed by light-irradiating the alignment agent and first alignment aids, and the second alignment polymer is formed by light-irradiating the liquid crystal molecules and second alignment aids and wherein the first alignment aids and the second alignment aids comprise a mesogen and a photo-polymerizable group coupled to the mesogen.

An exemplary embodiment of the present invention also discloses a method for manufacturing a liquid crystal display, including forming a field generating electrode on at least one of a first substrate and a second substrate, the second substrate facing the first substrate, forming an alignment layer on the field generating electrode, the alignment layer including an alignment agent and first alignment aids, assembling the first substrate and the second substrate, forming a liquid crystal layer between the first substrate and the second substrate, the liquid crystal layer including liquid crystal molecules and second alignment aids, applying a voltage between the first substrate and the second substrate, and forming a first alignment polymer and a second alignment polymer by light-irradiating the alignment layer and the liquid crystal layer, in a state in which the voltage is applied between the first substrate and the second substrate.

According to the present invention, the alignment layer and the liquid crystal molecules of the liquid crystal display include the alignment aids such that the exposure efficiency may be improved, and deterioration of the voltage holding ratio may be prevented.

It is to be understood that both the foregoing general description and the following detailed description are exemplary and explanatory and are intended to provide further explanation of the invention as claimed.

### BRIEF DESCRIPTION OF THE DRAWINGS

FIG. 1 is an equivalent circuit diagram of one pixel of a liquid crystal display according to an exemplary embodiment of the present invention.

FIG. 2 is a layout view of a liquid crystal display according to an exemplary embodiment of the present invention, and FIG. 3 is a cross-sectional view taken along the line III-III′ of FIG. 2.

FIG. 4 is a top plan view showing a pixel electrode according to an exemplary embodiment of the present invention.

FIG. 5 is a top plan view of a basic electrode in a liquid crystal display according to an exemplary embodiment of the present invention.

FIG. 6A and FIG. 6B are schematic diagrams showing a method for forming a pre-tilt of liquid crystal molecules through alignment aids according to an exemplary embodiment of the present invention.

FIG. 7 is a layout view of a liquid crystal display according to another exemplary embodiment of the present invention, and FIG. 8 is a cross-sectional view taken along the line VIII-VIII′ of FIG. 7.

FIG. 9 is a graph showing a voltage holding ratio according to existence of alignment aids in a liquid crystal layer.

FIG. 10A, FIG. 10B, FIG. 10C, and FIG. 10D are graphs showing a variation of a voltage holding ratio according to an irradiation amount of ultraviolet (UV) rays.

FIG. 11 is a graph showing an afterimage according to existence of alignment aids of a liquid crystal layer.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

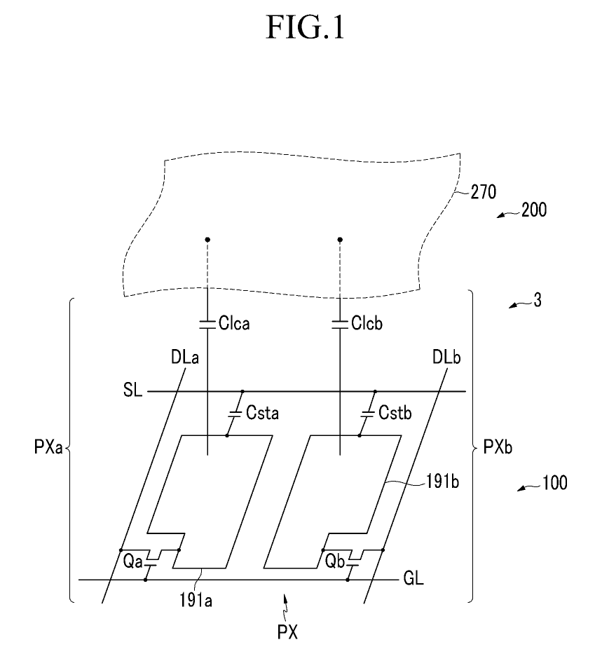

FIG. 1 is an equivalent circuit diagram of one pixel of a liquid crystal display according to an exemplary embodiment of the present invention.

Referring to FIG. 1, a liquid crystal display according to an exemplary embodiment of the present invention includes a thin film transistor array panel 100 and a common electrode panel 200 facing each other, and a liquid crystal layer 3 interposed therebetween.

The liquid crystal display according to an exemplary embodiment of the present invention includes signal lines including a plurality of gate lines GL, a plurality of pairs of data lines DLa and DLb, a plurality of storage electrode lines SL, and a plurality of pixels PX connected thereto.

The pixel PX includes a pair of sub-pixels PXa and PXb. The sub-pixel PXa includes a switching element Qa, a liquid crystal capacitor Clca, and a storage capacitor Csta. The sub-pixel PXb includes a switching element Qb, a liquid crystal capacitor Clcb, and a storage capacitor Cstb.

The switching element Qa and the switching element Qb are three-terminal elements, such as, for example, a thin film transistor, provided on the thin film transistor array panel 100. The switching element Qa includes a control terminal connected to the gate line GL, an input terminal connected to the data line DLa, and an output terminal connected to the liquid crystal capacitor Clca and the storage capacitor Csta. The switching element Qb includes a control terminal connected to the gate line GL, an input terminal connected to the data line DLb, and an output terminal connected to the liquid crystal capacitor Clcb and the storage capacitor Cstb.

The liquid crystal capacitor Clca and the liquid crystal capacitor Clcb each uses a common electrode 270 and a sub-pixel electrode 191a and a sub-pixel electrode 191b, respectively, as two terminals. The liquid crystal layer 3 between the sub-pixel electrode 191a and sub-pixel electrode 191b and the common electrode 270 functions as a dielectric material.

The storage capacitor Csta and the storage capacitor Cstb are coupled to the liquid crystal capacitor Clca and the liquid crystal capacitor Clcb, respectively. The storage capacitor Csta and the storage capacitor Cstb are formed between a storage electrode line SL provided on the thin film transistor array panel 100 and a sub-pixel electrode 191a and a sub-pixel electrode 191b, respectively. The sub-pixel electrode 191a and the sub-pixel electrode 191b are overlapped with an insulator interposed therebetween, and a voltage such as the common voltage Vcom may be applied thereto.

The voltage charged at the liquid crystal capacitor Clca may be slightly different from the voltage charged at the liquid crystal capacitor Clcb. For example, the data voltage applied to the liquid crystal capacitor Clca may be established to be always lower or higher than the data voltage applied to the corresponding liquid crystal capacitor Clcb. When the voltages of the liquid crystal capacitor Clca and the liquid crystal capacitor Clcb are properly controlled, an image viewed from the lateral side closely approximates an image viewed from the frontal side, thereby improving the lateral visibility of the liquid crystal display.

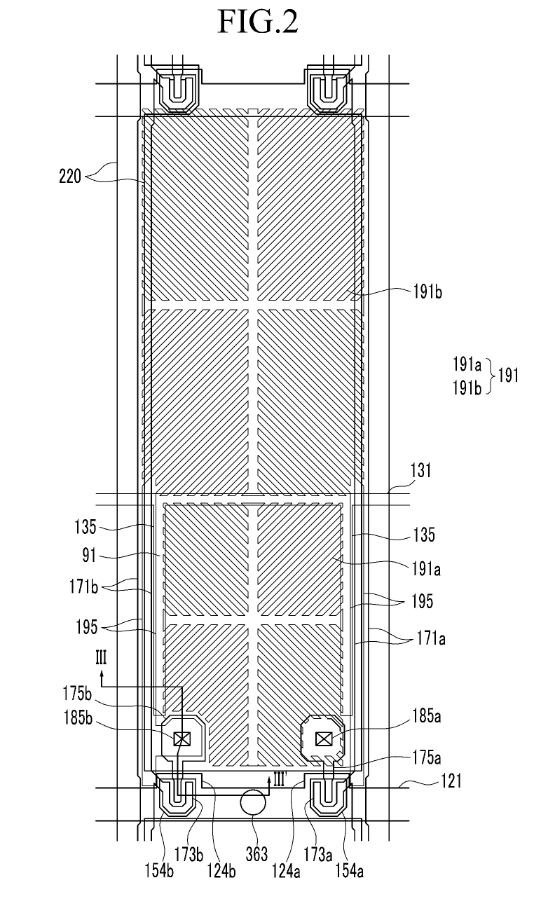

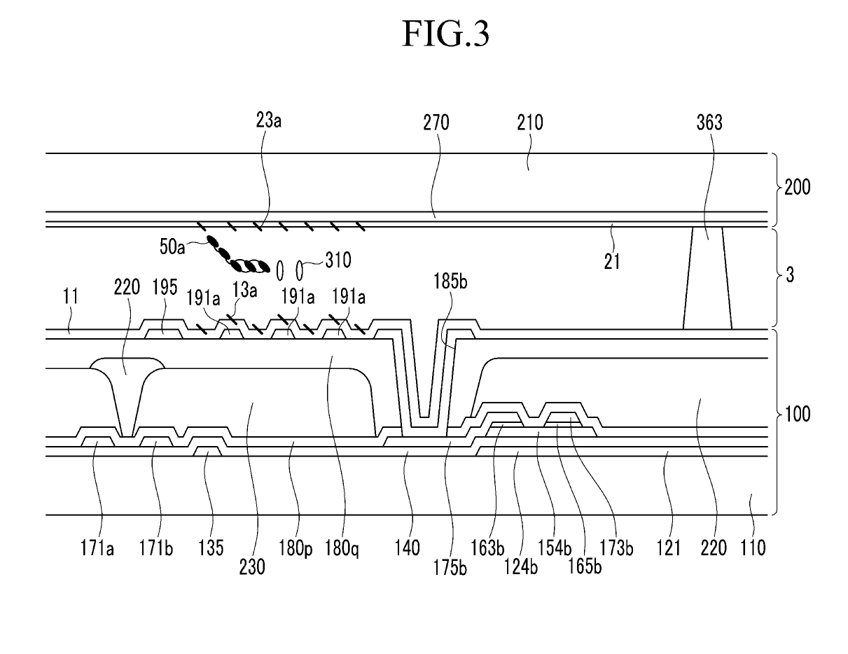

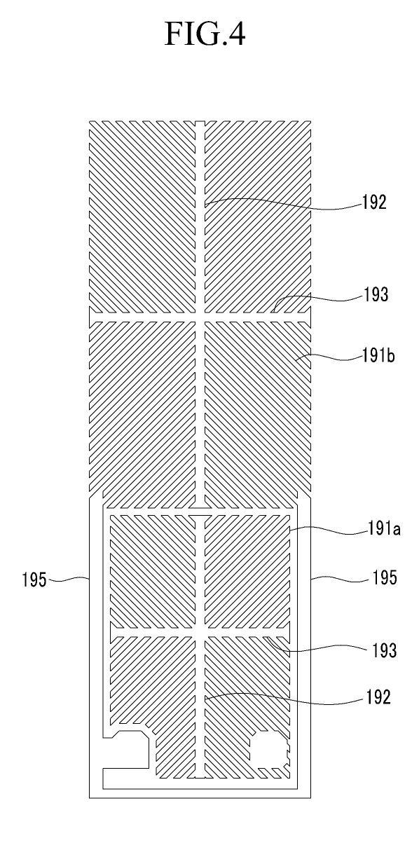

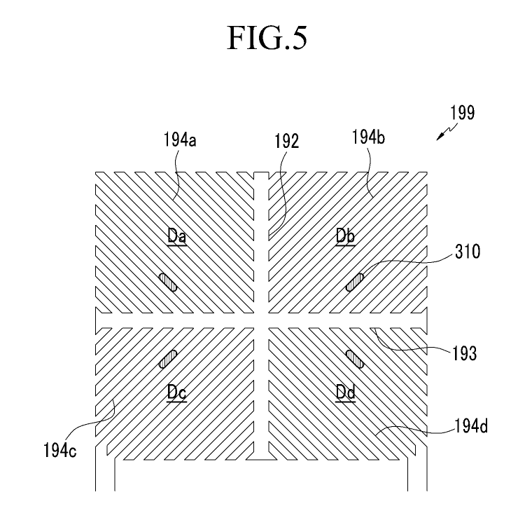

FIG. 2 is a layout view of a liquid crystal display according to an exemplary embodiment of the present invention, and FIG. 3 is a cross-sectional view taken along the line III-III′ of FIG. 2. FIG. 4 is a top plan view showing a pixel electrode according to an exemplary embodiment of the present invention. FIG. 5 is a top plan view of a basic electrode in a liquid crystal display according to an exemplary embodiment of the present invention.

Referring to FIG. 2 and FIG. 3, a liquid crystal display according to an exemplary embodiment of the present invention includes a thin film transistor array panel 100 and a common electrode panel 200 facing each other, and a liquid crystal layer 3 interposed between the thin film transistor array panel 100 and the common electrode panel 200.

The thin film transistor array panel 100 will be firstly described in detail.

A plurality of gate lines 121 and a plurality of storage electrode lines 131 and storage electrode lines 135 are disposed on an insulation substrate 110.

The gate lines 121 transmit gate signals and substantially extend in the transverse direction. Each gate line 121 includes a plurality of first gate electrodes 124a and second gate electrodes 124b protruding from the gate line 121.

The storage electrode lines 131 may extend substantially parallel to the gate lines 121, and the plurality of storage electrode lines 135 may extend away from the storage electrode lines 131.

However, the shapes and arrangements of the storage electrode lines 131 and the storage electrode lines 135 may be modified in various forms.

A gate insulating layer 140 is disposed on the gate line 121, the storage electrode line 131, and the storage electrode line 135, and semiconductors 154a and semiconductors 154b preferably made of amorphous or crystallized silicon are disposed on the gate insulating layer 140.

A pair of ohmic contacts 163b and 165b is disposed on the first semiconductor 154b, and the ohmic contact 163b and the ohmic contact 165b may each be formed of a silicide or of a material such as n+ hydrogenated amorphous silicon in which an n-type impurity is doped with a high concentration.

A pair of data lines 171a and 171b and a pair of drain electrodes 175a and 175b are disposed on the ohmic contact 163b and the ohmic contact 165b, and on the gate insulating layer 140.

The data lines 171a and the data lines 171b, which transmit data signals, extend substantially in the longitudinal direction, and cross the gate lines 121 and the storage electrode lines 131. The data lines 171a and the data lines 171b include a plurality of first source electrodes 173a and second source electrodes 173b, respectively. The data lines 171a and the data lines 171b extend toward the first gate electrode 124a and the second gate electrode 124b, respectively, and are curved with a “U” shape. The first source electrode 173a and the first drain electrode 175a are on one side of the first gate electrode 124a and the second gate electrode 124b, respectively, and the first drain electrode 175a and the second drain electrode 175b are on the opposite side of the first gate electrode 124a and the second gate electrode 124b, respectively.

The first drain electrode 175a and the second drain electrode 175b each include one end bordered by the first source electrode 173a and the second source electrode 173b, respectively. The other end of the first drain electrode 175a and the second drain electrode 175b extends away from the first source electrode 173a and the second source electrode 173b, respectively, and may have a wide area for connection to another layer.

The shapes and arrangement of the first drain electrodes 175a and the second drain electrodes 175b and the data lines 171a and the data lines 171b may be modified in various forms.

The first gate electrodes 124a, the first source electrodes 173a, and the first drain electrodes 175a form the first switching element Qa along with the first semiconductor 154a. The second gate electrode 124b, the second source electrode 173b, and the second drain electrode 175b form the second switching element Qb along with the second semiconductor 154b. The channel of the first switching element Qa and the second switching element Qb are respectively disposed on the first semiconductor 154a, between the first source electrode 173a and the first drain electrode 175a, and the second semiconductor 154b between the second source electrode 173b and the second drain electrode 175b.

The ohmic contact 163b, and the ohmic contact 165b are interposed between the underlying semiconductor 154b, and the overlying source electrode 173b, and drain electrode 175b, and reduce contact resistance between them. Ohmic contacts are interposed similarly with reference to semiconductor 154a. The semiconductor 154a and the semiconductor 154b have a portion that is exposed without being covered by the data line 171a, data line 171b, drain electrode 175a, or drain electrode 175b. A portion of the semiconductor 154a and the semiconductor 154b is arranged between the source electrode 173a and the drain electrode 175a and the source electrode 173b and the drain electrode 175b, respectively.

A lower passivation layer 180p, preferably made of silicon nitride or silicon oxide, is disposed on the data lines 171a, the data lines 171b, the drain electrode 175a, the drain electrode 175b, and the exposed portions of the semiconductor 154a and the semiconductor 154b.

A color filter 230 is disposed on the lower passivation layer 180p. The color filter 230 may include three color filters, one each of red, green, and blue. A light blocking member 220 made of a single layer or double layers such as chromium and chromium oxide or an organic material may be disposed on the color filter 230. The light blocking member 220 may have openings arranged in a matrix.

An upper passivation layer 180q made of a transparent organic insulating material may be disposed on the color filter 230 and the light blocking member 220. The upper passivation layer 180q prevents the color filter 230 from being exposed and provides a flat surface. The upper passivation layer 180q has a plurality of contact holes 185a and contact holes 185b exposing the first drain electrodes 175a and second drain electrodes 175b.

A plurality of pixel electrodes 191 are disposed on the upper passivation layer 180q. The pixel electrodes 191 may be formed with a transparent conductive material such as Indium Tin Oxide (ITO) and Indium Zinc Oxide (IZO), or with a reflective material such as aluminum, silver, chromium, and alloys thereof.

The pixel electrode 191 includes a first sub-pixel electrode 191a and a second sub-pixel electrode 191b separated from each other by a gap 91. The first sub-pixel electrode 191a and the second sub-pixel electrode 191b may include electrodes like the basic electrode 199 shown in FIG. 5 or variants thereof.

The basic electrode 199 will now be described in detail with reference to FIG. 4 and FIG. 5.

As shown in FIG. 5, the basic electrode 199 is quadrangular-shaped, and has a cross-shaped stem portion with a transverse stem 193 and a longitudinal stem 192, each extending perpendicular to the other. Furthermore, the basic electrode 199 is partitioned into first to fourth sub-regions (first sub-region Da, second sub-region Db, third sub-region Dc, and fourth sub-region Dd, collectively, “sub-regions D”) by way of the transverse stem 193 and the longitudinal stem 192. Also, the first sub-region Da has a plurality of first mini-branches 194a, the second sub-region Db has a plurality of second mini-branches 194b, the third sub-region Dc has a plurality of third mini-branches 194c, and the fourth sub-region Dd has a plurality of fourth mini-branches 194d. Collectively, the plurality of first mini-branches 194a, the plurality of second mini-branches 194b, the plurality of third mini-branches 194c, and the plurality of fourth mini-branches 194d are referred to as “mini branches 194.”

The plurality of first mini-branches 194a extends diagonally toward the top left of the page from the transverse stem 193 or the longitudinal stem 192. The plurality of second mini-branches 194b extends diagonally toward the top right of the page from the transverse stem 193 or the longitudinal stem 192. The plurality of third mini-branches 194c extends diagonally toward the bottom left of the page from the transverse stem 193 or the longitudinal stem 192. The plurality of fourth mini-branches 194d extends diagonally toward the bottom right of the page from the transverse stem 193 or the longitudinal stem 192.

The mini-branches 194 are angled to the longitudinal stem 192 or the transverse stem 193 by about 45 or 135 degrees. Furthermore, the mini-branches 194 of two neighboring sub-regions (for example, sub-region Da and sub-region Db) may extend perpendicular to each other.

The width of the mini-branches 194 may be in the range of 2.0 μm to 5.0 μm, and the interval between the neighboring mini-branches 194 of one of sub-regions D may be in the range of 2.5 μm to 5.0 μm.

Although not shown in the drawing, the widths of the mini-branches 194 closer to the transverse stem 193 or the longitudinal stem 192 may be greater than the widths of the mini-branches further away from the transverse stem 193 or the longitudinal stem 192.

Referring to FIG. 2, FIG. 3, FIG. 4, and FIG. 5 again, the first sub-pixel electrode 191a and the second sub-pixel electrode 191b each include one basic electrode 199. However, the area of the second sub-pixel electrode 191b of the pixel electrode 191 may be larger than the area of the first sub-pixel electrode 191a. In this case, the area of the second sub-pixel electrode 191b is larger than the area of the first sub-pixel electrode 191a by 1.0 to 2.2 times.

The second sub-pixel electrode 191b includes a pair of branches 195 extending parallel to the data lines 171a and the data lines 171b. The branches 195 are disposed between the first sub-pixel electrode 191a and the data lines 171a and data lines 171b, and are connected to a portion of the first sub-pixel electrode 191a near the bottom of the page. The first sub-pixel electrode 191a and the second sub-pixel electrode 191b are physico-electrically connected to the first drain electrode 175a and the second drain electrode 175b through the contact hole 185a and the contact hole 185b, respectively, so as to receive data voltages from the first drain electrode 175a and the second drain electrode 175b.

The common electrode panel 200 will now be described in detail.

Referring to the common electrode panel 200, a common electrode 270 is disposed on the entire surface of a transparent insulation substrate 210.

Spacers 363 space the common electrode panel 200 and the thin film transistor array panel 100 apart from each other.

Alignment layer 11 and alignment layer 21, which may be vertical alignment layers, are respectively coated on the inner surface of the thin film transistor array panel 100 and the common electrode panel 200. The alignment layer 11 and the alignment layer 21 may include at least one of materials generally used as a liquid crystal alignment layer, such as, for example, polyamic acid, a polyimide or a polysiloxane. The alignment layer 11 and the alignment layer 21 include the first alignment polymer 13a or the first alignment polymer 23a formed by irradiating the first alignment aids 13 or the first alignment aids 23, respectively.

Polarizers (not shown) may be provided on the outer surfaces of the thin film transistor array panel 100 and the common electrode panel 200.

A liquid crystal layer 3 is formed between the thin film transistor array panel 100 and the common electrode panel 200. The liquid crystal layer 3 includes a plurality of liquid crystal molecules 310, and a second alignment polymer 50a formed by irradiating light to a second alignment aid 50.

The liquid crystal molecules 310 have negative dielectric anisotropy, and may be oriented such that the major axes thereof are almost perpendicular to the surfaces of the thin film transistor array panel 100 and the common electrode panel 200 when no electric field is applied.

If voltages are applied to the pixel electrode 191 and the common electrode 270, the liquid crystal molecules 310 respond to the electric field generated between the pixel electrode 191 and the common electrode 270 such that the long axes thereof tend to become perpendicular to the electric field direction. The degree of polarization of the light that is incident to the liquid crystal layer 3 is changed according to the inclination degree of the liquid crystal molecules 310, and this change of polarization appears as a change of transmittance by the polarizer, thereby displaying images of the liquid crystal display.

The inclination direction of the liquid crystal molecules 310 is determined by the mini-branches 194 of the pixel electrodes 191. The liquid crystal molecules 310 are inclined in the direction parallel to the length direction of the mini-branches 194. In an exemplary embodiment of the present invention, the mini-branches 194 of one pixel PX are extended in four directions such that the inclined directions of the liquid crystal molecules 31 are all four directions. Thereby, four domains having different alignment directions of the liquid crystal molecules 310 are formed in the liquid crystal layer 3. Therefore, the viewing angle of the liquid crystal display may be widened by varying the inclined directions of the liquid crystal molecules.

The first alignment polymer 13a, the first alignment polymer 23a, and the second alignment polymer 50a formed by the polymerization of the first alignment aids 13, the first alignment aids 23, and the second alignment aids 50, respectively, control a pre-tilt as an initial alignment direction of the liquid crystal molecules 310. The first alignment aids 13, the first alignment aids 23, and the second alignment aids 50 may be a reactive mesogen.

The first alignment aids 13, the first alignment aids 23, and the second alignment aids 50 may be represented by Equation 1.

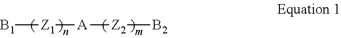

Here, m and n are independently 0 or 1.

“A” represents a reactive mesogen. The mesogen includes a structure in which two or more aromatic or aliphatic cyclic compounds are connected to each other at the center thereof.

“A” of Equation 1 may be any of the compounds represented by Formulae 1 to 7.

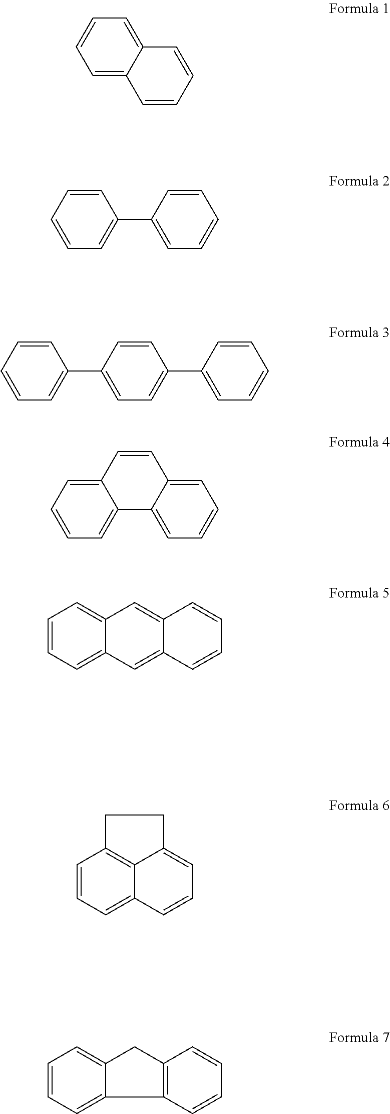

An outer hydrogen atom of the ring in the compound of the ring structure corresponding to “A” may be substituted with one of F, Cl, OCF3, OCH3, and an alkyl group of 1 to 6 carbon atoms. The first alignment aids 13, the first alignment aids 23, and the second alignment aids 50 may be any of the compounds represented by Formulae A to E.

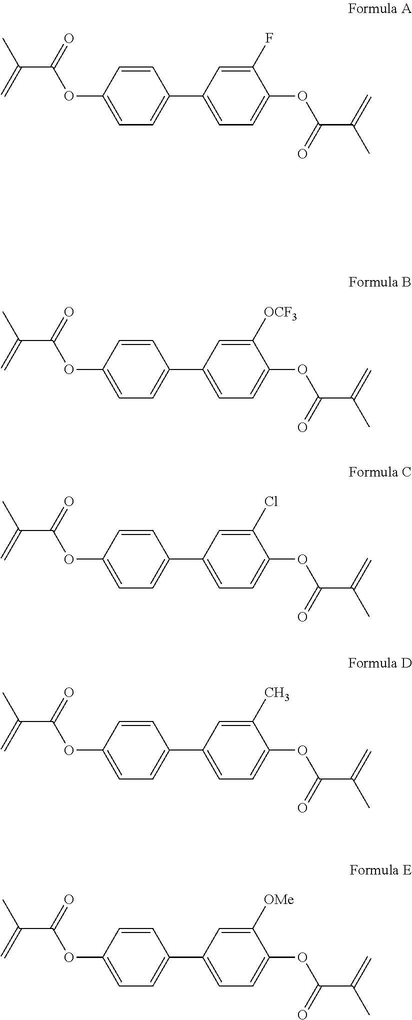

In Equation 1, Z1 and Z2 each may independently be any of the compounds represented by Formulae 8 to 12, and when m or n is 0, A and B1, or A and B2 may be single bonds.

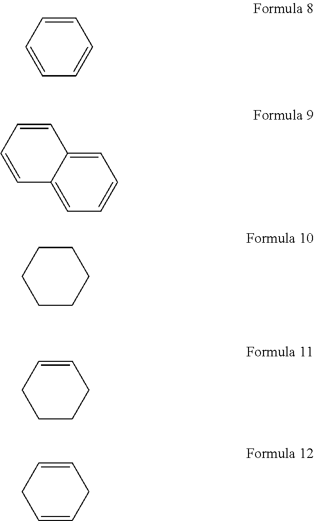

B1 and B2 as the terminal group of the first alignment aids 13 and the first alignment aids 23 or the second alignment aids 50 may correspond to a photo-polymerizable group.

In Equation 1, B1 and B2 may independently be any of the compounds represented by Formulae 13 and 14. However, B1 and B2 corresponding to the photo-polymerizable group are a functional group that is able to be polymerized by light, and are not limited to Formulae 13 and 14.

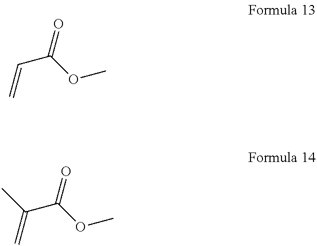

Z1 and Z2 may independently be a chain alkyl group of 3 to 12 carbon atoms disposed between the mesogen and the photo-polymerizable group. The chain alkyl group is disposed between the mesogen and the photo-polymerizable group thereby controlling a chain length such that it increases the polymerization degree when the first alignment aids 13 and the first alignment aids 23 or the second alignment aids 50 receive light.

The first alignment aids 13 and the first alignment aids 23 are in the range of 0.1 wt % to 20 wt % of the entire weight including the alignment layer 11, the alignment layer 21, the first alignment aids 13 and the first alignment aids 23. When the first alignment aids 13 and the first alignment aids 23 are less than 0.1 wt %, it is difficult to control the pre-tilt direction of the liquid crystal molecules 310, and when the first alignment aids 13 and the first alignment aids 23 are more than 20 wt %, the remaining alignment aids that are not polymerized after polymerizing may contain impurities.

A polymerization initiator may be included along with the first alignment aids 13 and the first alignment aids 23. The polymerization initiator may be 1 wt %. When including the polymerization initiator, the polymerization may occur quickly. However, the unreacted polymerization initiator is a remaining material that may be an impurity when it is present in an excessively large amount.

The second alignment aids 50 are in the range of 0.01 wt % to 1.0 wt % of the entire weight including the liquid crystal molecules 310 and the second alignment aids 50. When the second alignment aids 50 are less than 0.01 wt %, it is difficult to control the pre-tilt of the liquid crystal molecules 310, and when the second alignment aids 50 are more than 1.0 wt %, the content of the liquid crystal molecules 310 is decreased such that the display characteristic may be deteriorated.

The first alignment aids 13, the first alignment aids 23, and the second alignment aids 50 may be polymerized.

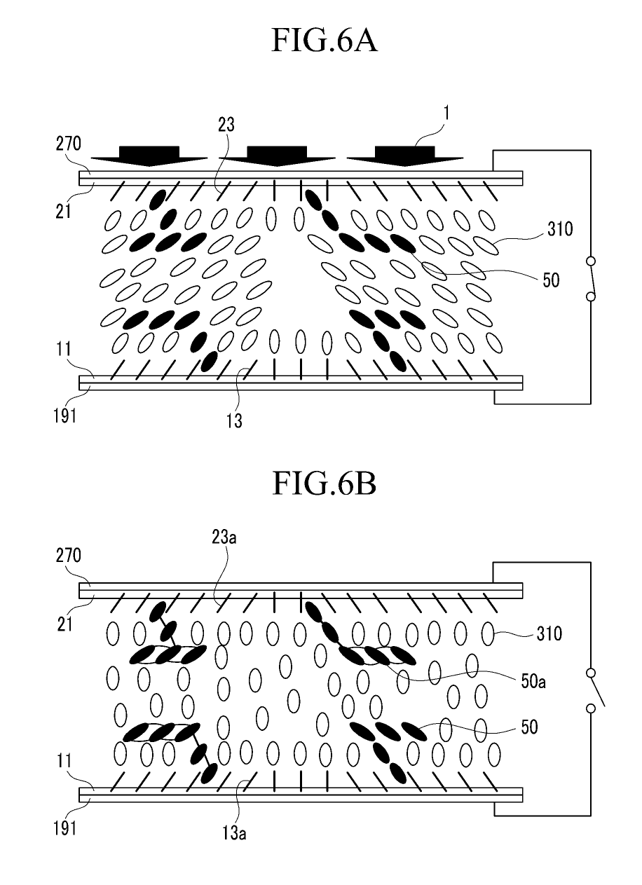

This will be described with reference to FIG. 6A and FIG. 6B as well as FIG. 2, FIG. 3, FIG. 4, and FIG. 5.

FIG. 6A and FIG. 6B are schematic diagrams showing a method for forming a pre-tilt of liquid crystal molecules through alignment aids according to an exemplary embodiment of the present invention.

Firstly, a thin film transistor array panel 100 and a common electrode panel 200 are respectively manufactured.

The thin film transistor array panel 100 is manufactured through the following method.

A plurality of thin films are deposited on an insulation substrate 110, and are patterned to sequentially form a gate line 121 including a first gate electrode 124a and a second gate electrode 124b, a gate insulating layer 140, a semiconductor 154a and a semiconductor 154b, data lines 171a and data lines 171b (respectively including a source electrode 173a and a source electrode 173b), a drain electrode 175a and a drain electrode 175b, and a lower passivation layer 180p.

Next, a color filter 230 is disposed on the lower passivation layer 180p, and a light blocking member 220 preventing light leakage is disposed on the color filter 230. An upper passivation layer 180q is disposed on the light blocking member 220 and the color filter 230.

A conductive layer such as ITO or IZO is deposited on the upper passivation layer 180q, and is patterned to form a pixel electrode 191 including a longitudinal stem 192, a transverse stem 193, and a plurality of mini-branches 194 extended therefrom.

Next, an alignment layer 11 including the first alignment aids 13 is coated on the pixel electrode 191.

The common electrode panel 200 is manufactured through the following method.

A common electrode 270 is disposed on a transparent insulation substrate 210. An alignment layer 21 including the first alignment aids 23 is coated on the common electrode 270.

Next, the thin film transistor array panel 100 and the common electrode panel 200 that are manufactured through the above-described method are assembled, and a liquid crystal layer 3 is formed by injecting a mixture of liquid crystal molecules 310 and the above-described second alignment aids 50 therebetween. Alternatively, the liquid crystal layer 3 may be formed by a method in which the mixture of the liquid crystal molecules 310 and the second alignment aids 50 is dripped on the thin film transistor array panel 100 or the common electrode panel 200.

Next, referring to FIG. 6A and FIG. 5, voltages are applied to the pixel electrode 191 and the common electrode 270. The first alignment aids 13 and the first alignment aids 23 included in the alignment layer 11 and the alignment layer 21 are extended from the inner part of the alignment layer 11 and the alignment layer 21 thereby forming a pre-tilt. The liquid crystal molecules 310 and the second alignment aids 50 are inclined in a direction parallel to the length direction of the minute branches 194a-194d of the pixel electrode 191 by the application of the voltages.

First light 1 is irradiated in a state in which the voltages are applied between the pixel electrode 191 and common electrode 270. The first light 1 has a wavelength, such as ultraviolet rays, that can polymerize the first alignment aids 13, the first alignment aids 23, and the second alignment aids 50.

Referring to FIG. 6B, the first alignment polymers 13a and the first alignment polymers 23a extended from the alignment layer 11 and the alignment layer 21 are formed by polymerizing the first alignment aids 13 and the first alignment aids 23 included in the alignment layer 11 and the alignment layer 21 after the light irradiation, and the neighboring second alignment aids 50 are light-polymerized thereby forming the second alignment polymers 50a. The first alignment polymers 13a, the first alignment polymers 23a, and the second alignment polymers 50a are arranged according to the alignment of the liquid crystal molecules 310, and the arrangement is maintained after the applied voltage is removed thereby controlling the pre-tilt of the liquid crystal molecules 310.

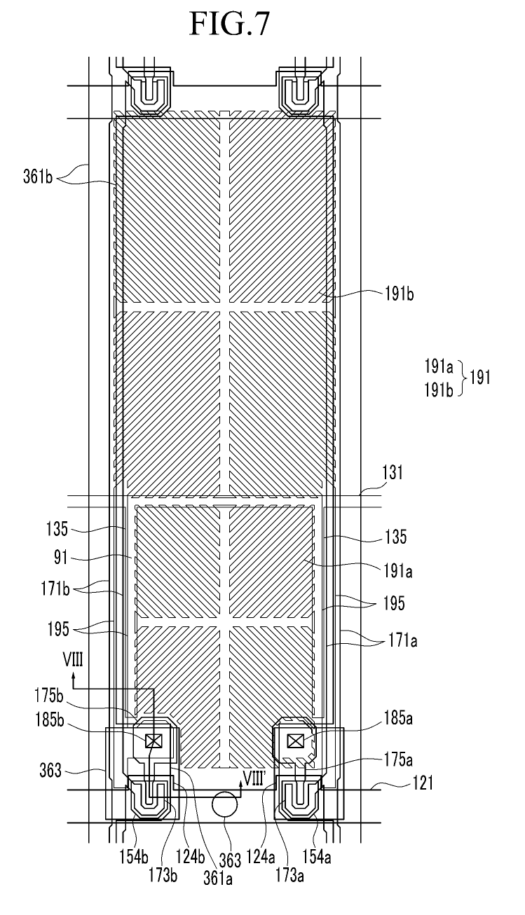

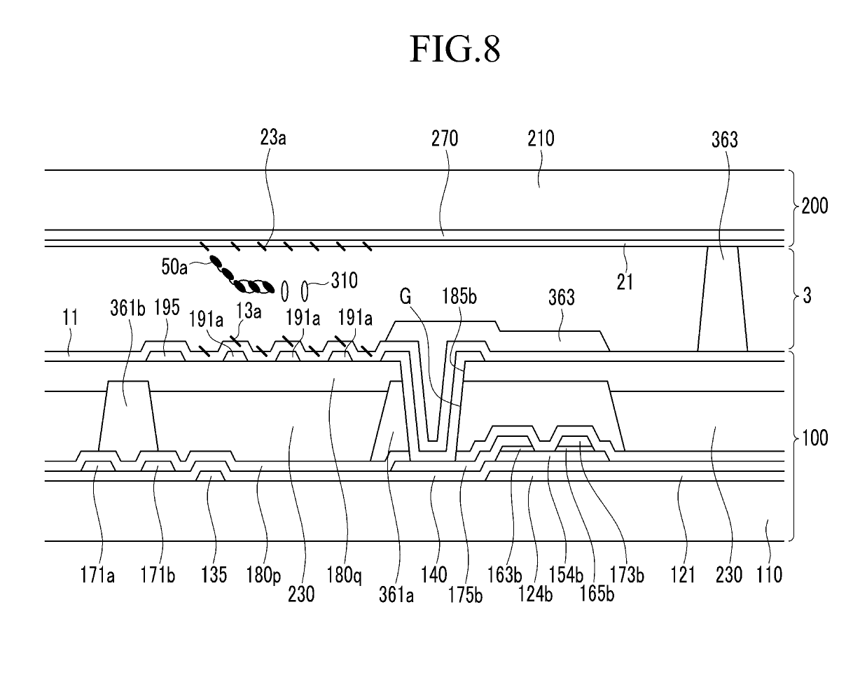

FIG. 7 is a layout view of a liquid crystal display according to another exemplary embodiment of the present invention, and FIG. 8 is a cross-sectional view taken along the line VIII-VIII′ of FIG. 7.

Different elements from the previous exemplary embodiment will be described in the current exemplary embodiment of the present invention.

Referring to FIG. 7 and FIG. 8, a liquid crystal display according to an exemplary embodiment of the present invention includes a thin film transistor array panel 100 and a common electrode panel 200 facing each other, and a liquid crystal layer 3 interposed between the thin film transistor array panel 100 and the common electrode panel 200.

A plurality of thin films are deposited on an insulation substrate 110 and are patterned to sequentially form a gate line 121 including a first gate electrode 124a and a second gate electrode 124b, a gate insulating layer 140, a semiconductor 154a and a semiconductor 154b, data lines 171a and data lines 171b (respectively including a source electrode 173a and a source electrode 173b), a drain electrode 175a and a drain electrode 175b, and a lower passivation layer 180p.

A partition is disposed on the lower passivation layer 180p. The partition is formed according to the gate line 121, the data line 171a and the data line 171b, and is also disposed on the thin film transistor. A region enclosed by the partition substantially forms a rectangle as a filling region where a color filter 230 is disposed.

The partition includes a first partition 361a disposed on the thin film transistor, and a second partition 361b disposed on the data lines 171a and the data lines 171b. Specifically, the first partition 361a has openings “G” through which the first drain electrodes 175a and the second drain electrodes 175b are exposed. The second partition 361b is disposed between neighboring data line 171a and data line 171b such that it partially overlaps the data line 171a and the data line 171b.

An inkjet material for color filters 230 fills the region surrounded by the partition 361a and the partition 361b. The color filters 230 may be formed through inkjet printing. An upper passivation layer 180q is disposed on the color filters 230. The upper passivation layer 180q is also disposed on the partition 361a and the partition 361b so as to flatten the underlying layer.

The upper passivation layer 180q may be formed of a photosensitive organic material. In addition to the openings G, a contact hole 185a and a contact hole 185b are formed at the upper passivation layer 180q so as to expose the first drain electrode 175a and the second drain electrode 175b.

A plurality of pixel electrodes 191 are disposed on the upper passivation layer 180q. The pixel electrodes 191 may be formed with a transparent conductive material such as ITO and IZO, or with a reflective material such as aluminum, silver, chromium, and alloys thereof.

Referring to the common electrode panel 200, a common electrode 270 is disposed on a transparent insulation substrate 210.

A spacer 363 for maintaining an interval between the common electrode panel 200 and the thin film transistor array panel 100 is disposed on the gate line 121 or the thin film transistor. The spacer 363 disposed on the thin film transistor overlaps the first source electrode 173a or second source electrode 173b and the first drain electrode 175a or second drain electrode 175b, and may fill the opening “G” of the first partition 361a and the contact hole 185b of the upper passivation layer 180q on the pixel electrode 191.

Alignment layer 11 and alignment layer 21, which may be vertical alignment layers, are respectively coated on the inner surface of the thin film transistor array panel 100 and the common electrode panel 200.

Polarizers (not shown) may be provided on the outer surfaces of the thin film transistor array panel 100 and the common electrode panel 200.

A liquid crystal layer 3 is formed between the thin film transistor array panel 100 and the common electrode panel 200. The liquid crystal layer 3 includes the second alignment polymer 50a formed by irradiating light to a plurality of liquid crystal molecules 310 and the second alignment aids 50.

The liquid crystal molecules 310 have negative dielectric anisotropy, and may be oriented such that the major axes thereof are almost perpendicular to the surfaces of the thin film transistor array panel 100 and the common electrode panel 200 when no electric field is applied.

The descriptions of the alignment layer 11 and the alignment layer 21, the first alignment aids 13 and the first alignment aids 23, the second alignment aids 50, the first alignment polymers 13a and the second alignment polymers 23a, and the second alignment polymers 50a in the above-described exemplary embodiment of the present invention may also be applied here.

Next, for when the alignment layers and the liquid crystal layer 3 include the alignment aids, a voltage holding ratio and an afterimage improvement effect will be described.

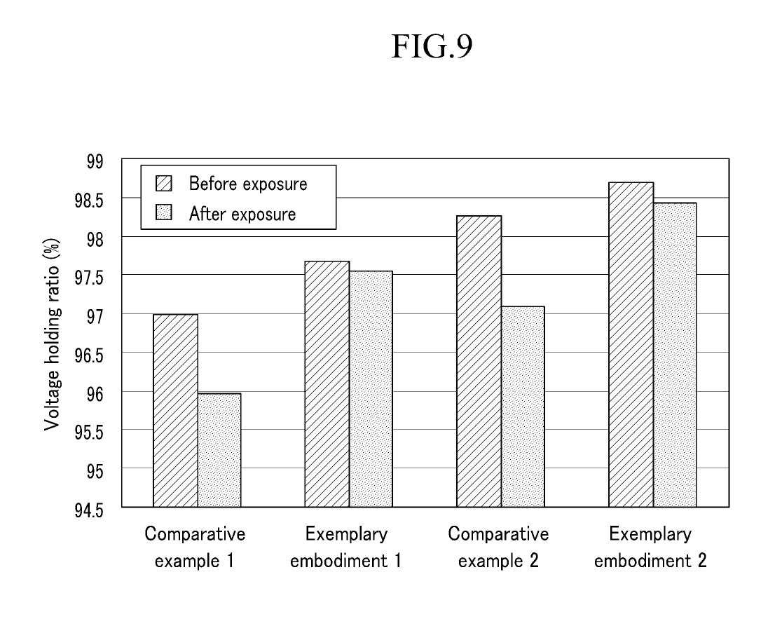

FIG. 9 is a graph showing a voltage holding ratio according to existence of alignment aids in a liquid crystal layer.

Referring to Table 1, the voltage holding ratio is decreased about 1.0% to 1.1% by the exposure of 50 J/_{cm}² for the case in which the liquid crystal layer 3 does not include a reactivity mesogen (RM) (corresponding to Comparative Example 1 and Comparative Example 2, in FIG. 9). However, when the liquid crystal layer 3 includes the reactivity mesogen (RM), the voltage holding ratio by the same exposure decreases about 0.1% to 0.2%. FIG. 9 shows this effect.

TABLE 1

| | Content of | | Voltage | Voltage | Difference of |
|---|---|---|---|---|---|
| | RM in an | Existence of RM | holding | holding | voltage |
| | alignment | in liquid crystal | ratio (before | ratio (after | holding |
| | layer | (content) | exposure) | exposure) | ratios |
| Comparative | 1% | No | 99.99% | 95.96% | −1.02667% |
| Example 1 | | | | | |
| Exemplary | 1% | Yes (0.2%) | 97.66% | 97.55% | −0.11667% |
| embodiment | | | | | |
| 1 | | | | | |
| Comparative | 2% | No | 98.25% | 97.09% | −1.16667% |
| Example 2 | | | | | |
| Exemplary | 2% | Yes (0.2%) | 98.69% | 98.43% | −0.26% |
| embodiment | | | | | |
| 2 | | | | | |

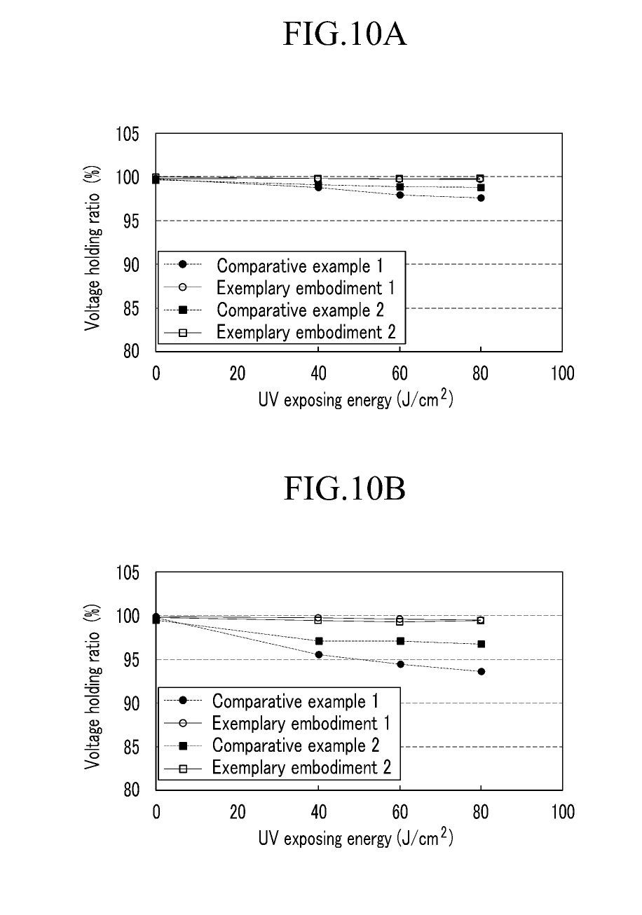

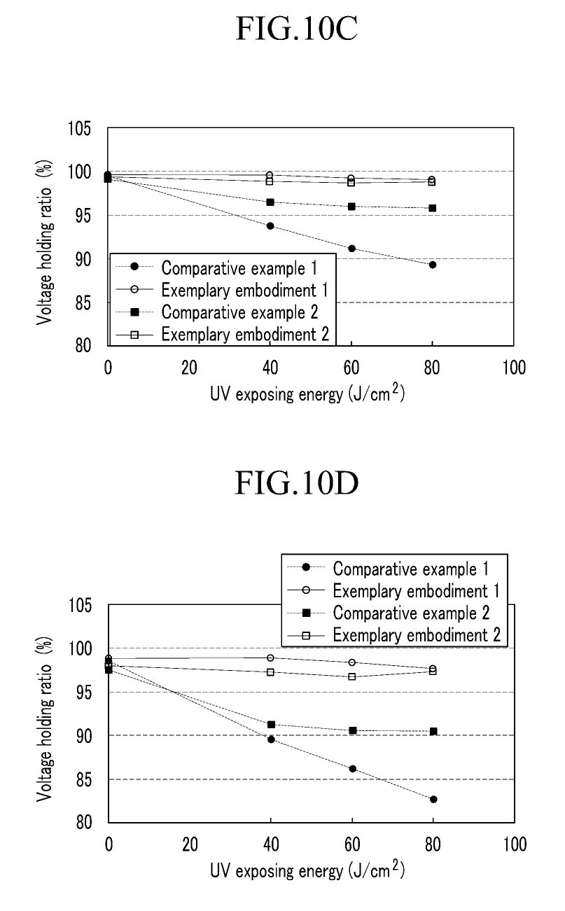

FIG. 10A, FIG. 10B, FIG. 10C, and FIG. 10D are graphs showing variation of a voltage holding ratio according to an irradiation amount of ultraviolet (UV) rays.

FIG. 10A shows a voltage holding ratio according to exposure energy in the case of UV exposure in a condition of 60 Hz and 22 degrees Celsius. FIG. 10B shows a voltage holding ratio according to exposure energy in the case of UV exposure in a condition of 60 Hz and 60 degrees Celsius. FIG. 10C shows a voltage holding ratio according to exposure energy in the case of UV exposure in a condition of 5 Hz and 22 degrees Celsius. FIG. 10D shows a voltage holding ratio according to exposure energy in the case of UV exposure in a condition of 5 Hz and 60 degrees Celsius.

In the case of Comparative Example 1 and Comparative Example 2 in which the liquid crystal layer does not include the alignment aids, the liquid crystal layer is damaged by UV such that the voltage holding ratio is largely reduced. As the exposure energy is increased, the voltage holding ratio is greatly reduced.

However, in the case of Exemplary Embodiment 1 and Exemplary Embodiment 2 in which the liquid crystal layer includes the alignment aids, although the exposure energy is large, the voltage holding ratio is minimally reduced.

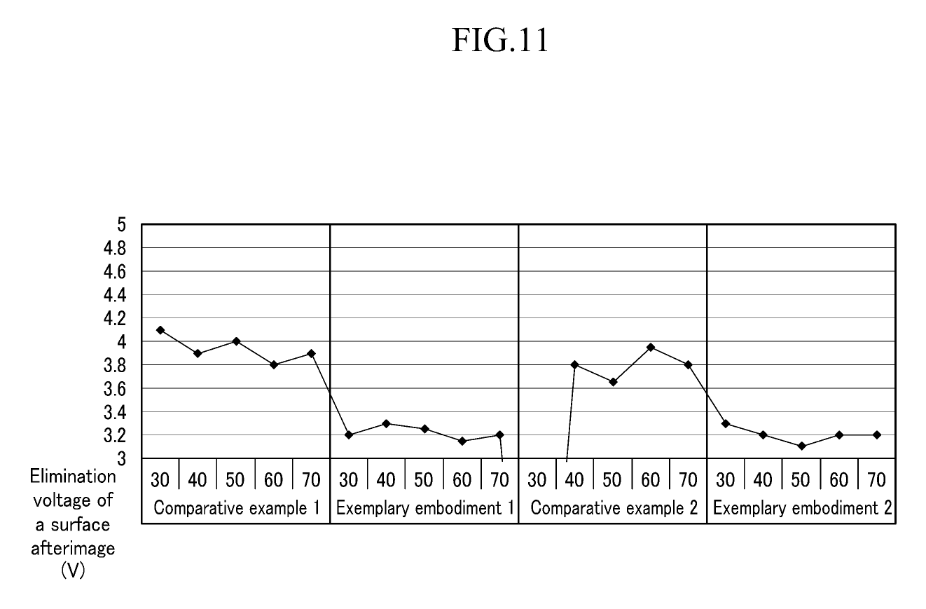

FIG. 11 is a graph showing an afterimage according to existence of alignment aids of a liquid crystal layer.

Referring to Table 2, in the case of Comparative Example 1 and Comparative Example 2 in which the liquid crystal layer does not include the alignment aids (RM), an elimination voltage of the surface afterimage is in the range of 3.8V to 4.0V. However, in the case of Exemplary Embodiment 1 and Exemplary Embodiment 2 in which the liquid crystal layer includes the alignment aids (RM), the elimination voltage of the surface afterimage is about 3.2V.

TABLE 2

| | Content of RM | | | | | | | | | | | | | | | | | | | |
|---|---|---|---|---|---|---|---|---|---|---|---|---|---|---|---|---|---|---|---|---|
| | in an alignment | | | | | | | | | | | | | | | | | | | |
| | layer | | | | | | | | | | | | | | | | | | | |
| | 1 wt % | | | | | | | | | | 2 wt % | | | | | | | | | |
| | Liquid crystal | | | | | | | | | | | | | | | | | | | |
| | | | | | | Exemplary | | | | | | | | | | Exemplary | | | | |
| | Comparative 1 | | | | | Embodiment 1 | | | | | Comparative 2 | | | | | Embodiment 2 | | | | |
| Exposure amount | 30 | 40 | 50 | 60 | 70 | 30 | 40 | 50 | 60 | 70 | 30 | 40 | 50 | 60 | 70 | 30 | 40 | 50 | 60 | 70 |
| (J/cm²) | | | | | | | | | | | | | | | | | | | | |
| Elimination voltage | 4.1 | 3.9 | 4 | 3.8 | 3.9 | 3.2 | 3.3 | 3.25 | 3.15 | 3.2 | X | 3.8 | 3.65 | 3.95 | 3.8 | 3.3 | 3.2 | 3.1 | 3.2 | 3.2 |
| of the surface | | | | | | | | | | | | | | | | | | | | |
| afterimage (V) | | | | | | | | | | | | | | | | | | | | |

Thus, in the case that the alignment layer and the liquid crystal layer both include the alignment aids (RM), the elimination voltage of the surface afterimage is improved about 0.7V compared with the case of only the alignment layer including the alignment aids (RM). This result appears in FIG. 11.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display comprising:
a first substrate;
a second substrate facing the first substrate;
a field generating electrode disposed on at least one of the first substrate and the second substrate;
an alignment layer disposed on the field generating electrode, the alignment layer comprising an alignment agent and a first alignment polymer; and
a liquid crystal layer interposed between the first substrate and the second substrate, the liquid crystal layer comprising liquid crystal molecules and a second alignment polymer,
wherein the first alignment polymer is formed by light-irradiating the alignment agent and first alignment aids, and the second alignment polymer is formed by light-irradiating the liquid crystal molecules and second alignment aids, and
wherein the first alignment aids and the second alignment aids comprise a mesogen and a photo-polymerizable group coupled to the mesogen.

2. The liquid crystal display of claim 1, wherein
the field generating electrode has a plurality of mini branches, and the width of the mini branches is in the range of 2 to 5 micrometers.

3. The liquid crystal display of claim 1, wherein
the first substrate is a thin film transistor substrate,
the second substrate is a common electrode substrate, and
the thin film transistor substrate comprises at least one of a color filter and a black matrix.

4. The liquid crystal display of claim 1, wherein
the first alignment aids and the second alignment aids are represented by Equation 1: 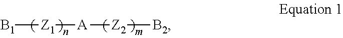
where m and n are independently 0 or 1.

5. The liquid crystal display of claim 4, wherein,
in Equation 1, A comprises a compound represented by one of Formulae 1 to 7:

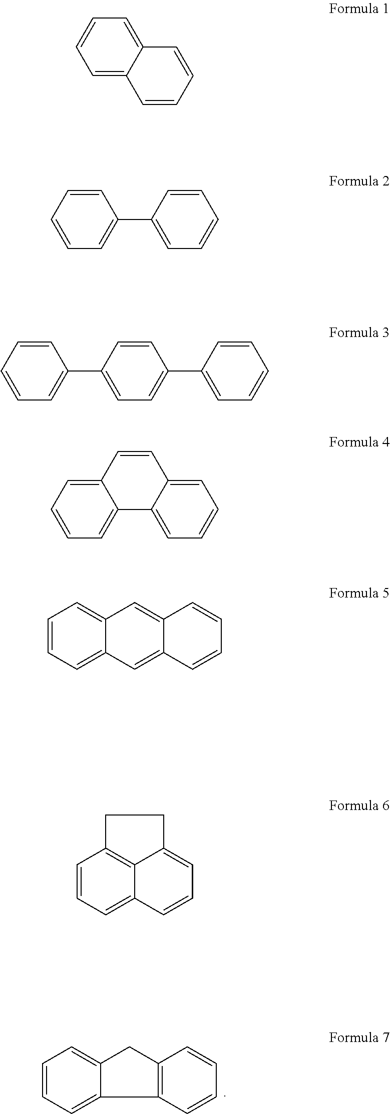

6. The liquid crystal display of claim 5, wherein,
in Equation 1, Z1 and Z2 each independently comprise a compound represented by one of Formulae 8 to 12: 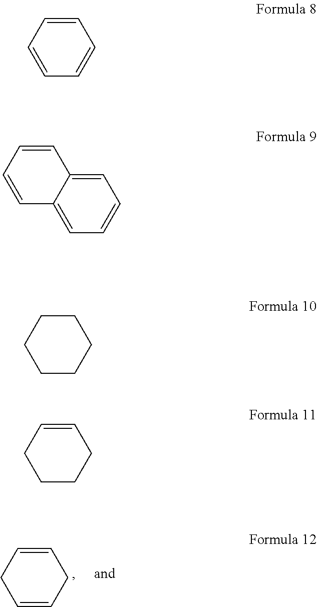
if morn is 0, A and B1, or A and B2, are single bonds.

7. The liquid crystal display of claim 6, wherein,
in Equation 1, B1 and B2 each independently comprise a compound represented by one of Formulae 13 and 14:

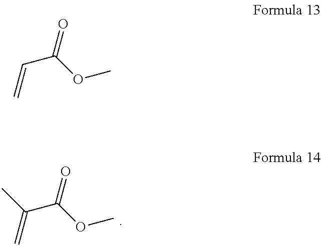

8. The liquid crystal display of claim 5, wherein,
in Formulae 1 to 7, an outer hydrogen atom is substituted with one of F, Cl, OCF3, OCH3, and an alkyl group of 1 to 6 carbon atoms.

9. The liquid crystal display of claim 1, wherein
the alignment agent is one of polyamic acid, a polyimide, and a polysiloxane.

10. The liquid crystal display of claim 9, wherein
the first alignment aids are included at 0.1 wt % to 20 wt % with respect to the total content of the alignment layer.

11. The liquid crystal display of claim 1, wherein
the second alignment aids are included at 0.01 wt % to 1.0 wt % with respect to the total content of the liquid crystal layer.

12. A method for manufacturing a liquid crystal display, comprising:
forming a field generating electrode on at least one of a first substrate and a second substrate, the second substrate facing the first substrate;
forming an alignment layer on the field generating electrode, the alignment layer comprising an alignment agent and first alignment aids;
assembling the first substrate and the second substrate;
forming a liquid crystal layer between the first substrate and the second substrate, the liquid crystal layer comprising liquid crystal molecules and second alignment aids;
applying a voltage between the first substrate and the second substrate; and
forming a first alignment polymer and a second alignment polymer by light-irradiating the alignment layer and the liquid crystal layer, in a state in which the voltage is applied between the first substrate and the second substrate.

13. The method of claim 12, wherein
the field generating electrode has a plurality of mini branches, and the width of the mini branches is in the range of 2 to 5 micrometers.

14. The method of claim 12, wherein
the first alignment aids and the second alignment aids are represented by Equation 1: 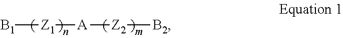
where, m and n are independently 0 or 1.

15. The method of claim 14, wherein,
in Equation 1, A comprises a compound represented by one of Formulae 1 to 7:

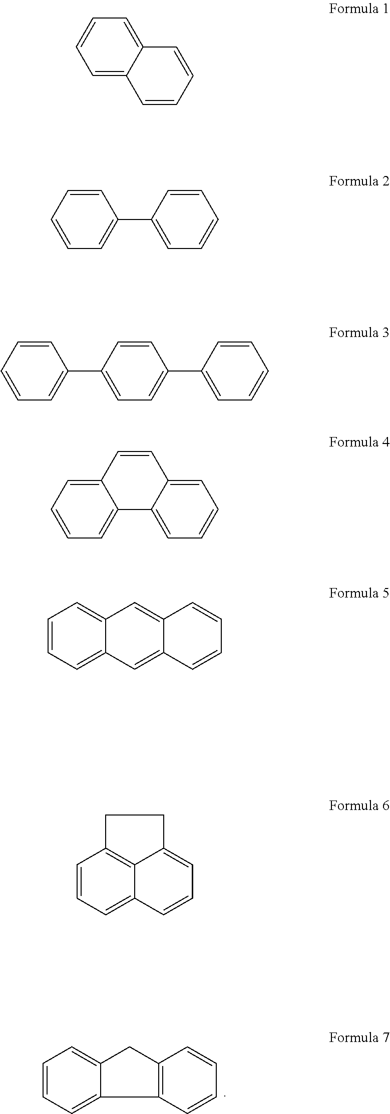

16. The method of claim 15, wherein,
in Equation 1, Z1 and Z2 each independently comprise a compound represented by one of Formulae 8 to 12: 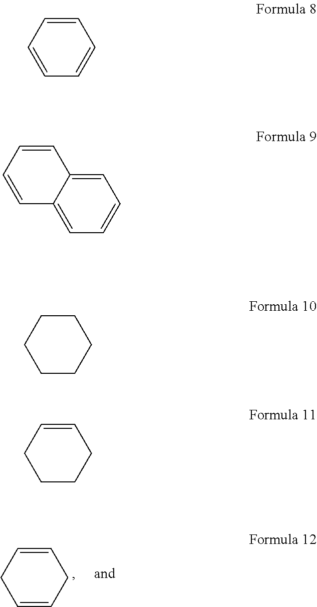
if morn is 0, A and B1, or A and B2, are single bonds.

17. The method of claim 16, wherein,
in Equation 1, B1 and B2 each independently comprise a compound represented by one of Formulae 13 and 14:

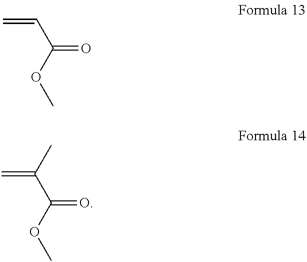

18. The method of claim 15, wherein,
in Formulae 1 to 7, an outer hydrogen atom is substituted with one of F, Cl, OCF3, OCH3, and an alkyl group of 1 to 6 carbon atoms.

19. The method of claim 12, wherein
the alignment agent is one of polyamic acid, a polyimide, and a polysiloxane.

20. The method of claim 12, wherein
the forming of the first alignment polymer and the second alignment polymer further comprises irradiating the light in a state in which the voltage is not applied after the light-irradiating.

21. The method of claim 12, wherein
the first substrate is a thin film transistor substrate,
the second substrate is a common electrode substrate, and
the thin film transistor substrate comprises at least one of a color filter and a black matrix.

22. The method of claim 21, wherein
the first substrate comprises a column spacer to form a cell gap within the liquid crystal molecules.

23. The method of claim 22, wherein
the column spacer is disposed between neighboring pixel areas.

24. The method of claim 23, wherein
the column spacer comprises a transparent material or an opaque material.

25. The method of claim 24, wherein
the black matrix and the column spacer are simultaneously formed.
